(19) United States
(12) Patent Application Publication
(10) Pub. No.: US 2010/0274411 A1
(43) Pub. Date: Oct. 28, 2010

(54) DRUNK DRIVING PREVENTION APPARATUS

(75) Inventor: Osamu Ozaki, Shizuoka (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/747,197

(22) PCT Filed: Dec. 8, 2008
(86) PCT No.: PCT/JP2008/072269

§ 371 Date: Jun. 10, 2010

(30) Foreign Application Priority Data
Dec. 10, 2007 (JP) 2007-318659

(51) Int. Cl. G06F 7/00

(52) U.S. Cl. 701/1

(57) ABSTRACT

Disclosed is a drunk driving prevention apparatus which reliably prevents drunk driving while permitting the release of control for restraining vehicle travel at an appropriate timing. A drunk driving prevention apparatus 1 prevents drunk driving of the vehicle by the driver includes a vehicle control part 13 which performs control for restraining vehicle travel when the drunken state of the driver is detected by a drunken state determination part 12. The drunk driving prevention apparatus 1 includes an emergency signal receiver 14 which detects occurrence of an emergency, and a vehicle control release mechanism part 16 which permits the release of control by the vehicle control part 13 when the drunken state of the driver is detected and the occurrence of an emergency is detected by the emergency signal receiver 14.

### TECHNICAL FIELD

The present invention relates to a drunk driving prevention apparatus which includes control means for performing control for restraining vehicle travel when the drunken state of a driver is detected, thereby preventing drunk driving of the vehicle by the driver.

### BACKGROUND ART

In order to prevent drunk driving, a drunk driving prevention apparatus, such as an alcohol interlock system, is known. For example, Patent Citation 1 describes a technique in which it is determined whether the alcohol concentration is equal to or greater than a predetermined value or not, and when the alcohol concentration is equal to or greater than the predetermined concentration, performs control for disabling the start of the vehicle. A release switch is provided which permits the start of the vehicle (that is, releases the control for disabling the start) even when the alcohol concentration is equal to or greater than the predetermined value, and at the time of an emergency when drunk driving is required for immediate treatment of a patient, the driver can operate the release switch to start and drive the vehicle.

### Citation List

### Patent Citation 1: Japanese Unexamined Patent Application Publication No. 2007-106277

### SUMMARY OF INVENTION

### Technical Problem

According to the technique described in Patent Citation 1, there is no consideration of limitation to the operation of the release switch by the driver, and the operation is possible other than in an emergency. For this reason, even a time when the release of the control for restraining vehicle travel, such as the start of the vehicle, should not be carried out, the release of control may be permitted, and it may be impossible to reliably prevent drunk driving.

It is an object of the invention to provide a drunk driving prevention apparatus which reliably prevents drunk driving while permitting the release of control for restraining vehicle travel at an appropriate timing.

### Technical Solution

A drunk driving prevention apparatus according to the invention which prevents drunk driving of a vehicle by a driver includes control module for performing control for restraining vehicle travel when the drunken state of the driver is detected, detection module for detecting occurrence of an emergency, and control release module for permitting the release of control by the control module when the drunken state of the driver is detected and the occurrence of an emergency is detected by the detection module.

In the invention, when the drunken state of the driver is detected and occurrence of an emergency is detected by the detection module, the control release module permits the release of control by the control module. Thus, even if the drunken state is detected, when occurrence of an emergency is detected, the release of control for restraining vehicle travel is permitted, so there is no case where the release of control for restraining travel of a vehicle, such as an automobile, is carried out at an inappropriate timing. For this reason, drunk driving can be reliably prevented while the release of control for restraining vehicle travel is permitted at an appropriate timing.

The detection module may detect an emergency when it is estimated that the distance from the vehicle to a shelter for protecting the driver is equal to or greater than a predetermined distance.

With this configuration, when it is estimated that the distance from the vehicle to the shelter is equal to or greater than the predetermined distance, the detection module detects the emergency. For this reason, even if the drunken state is detected, when it is estimated that the distance is equal to or greater than the predetermined distance, the release of control for restraining vehicle travel is permitted. Therefore, vehicle travel can be permitted to move the driver in the drunken state to the shelter. As a result, drunk driving can be reliably prevented while the release of control for restraining vehicle travel can be permitted at an appropriate timing.

The detection module may detect an emergency when it is estimated that the time required for travel from the vehicle to a shelter for protecting the driver is equal to or greater than a predetermined time.

With this configuration, when it is estimated that the time required for travel from the vehicle to the shelter is equal to or greater than the predetermined time, the detection module detects the emergency. For this reason, even if the drunken state is detected, when it is estimated that the time is equal to or greater than the predetermined time, the release of control for restraining vehicle travel is permitted. Therefore, vehicle travel can be permitted to move the driver in the drunken state to the shelter of the driver. As a result, drunk driving can be reliably prevented while the release of control for restraining vehicle travel can be permitted at an appropriate timing.

### ADVANTAGEOUS EFFECTS

According to the invention, a drunk driving prevention apparatus can be provided which reliably prevents drunk driving while permitting the release of control for restraining vehicle travel at an appropriate timing.

### BRIEF DESCRIPTION OF DRAWINGS

FIG. 1 is a schematic diagram showing the configuration of a drunk driving prevention apparatus according to a first embodiment.

FIG. 2 is a flowchart of processing which is executed in the first embodiment.

FIG. 3 is a flowchart of processing which is executed in a second embodiment.

FIG. 4 is a flowchart of processing which is executed in a third embodiment.

FIG. 5 is a flowchart of processing which is executed in a fourth embodiment.

FIG. 6 is a flowchart of processing which is executed in a fifth embodiment.

FIG. 7 is a flowchart of processing which is executed in a sixth embodiment.

### REFERENCE SINGS LIST

1: drunk driving prevention apparatus
11: drunken state detection sensor
12: drunken state determination part
13: vehicle control part
14: emergency signal receiver
15: navigation system
16: vehicle control release mechanism part
151: VICS
152: GPS receiver

### DESCRIPTION OF EMBODIMENTS

Hereinafter, preferred embodiments of the invention will be described in detail with reference to the accompanying drawings. For ease of understanding, in the drawings, the same parts are represented by the same reference numerals, and overlap description will be omitted.

### (1) First Embodiment

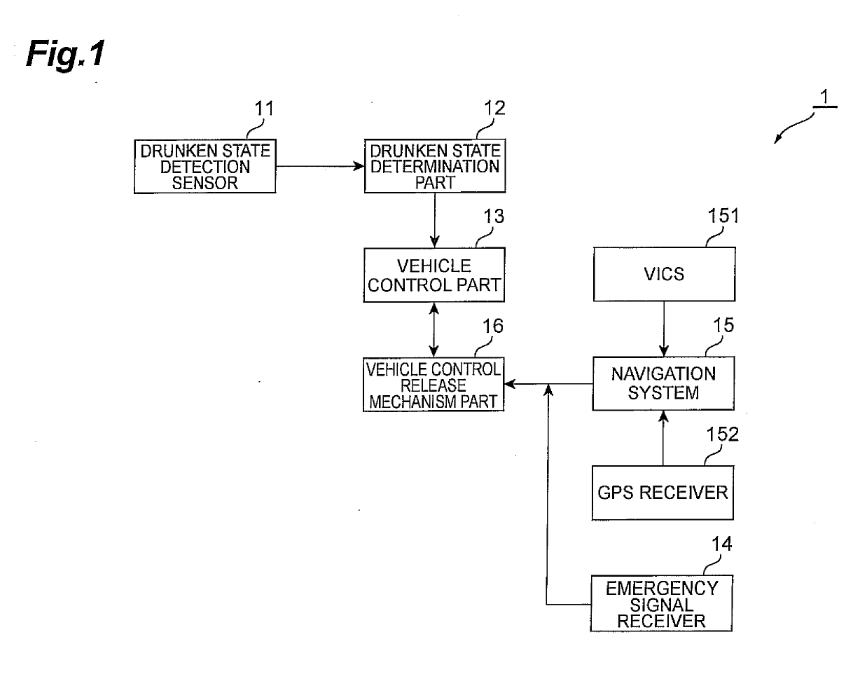

First, the configuration of a drunk driving prevention apparatus according to a first embodiment of the invention will be described with reference to FIG. 1. FIG. 1 is a schematic view showing the configuration of the drunk driving prevention apparatus 1 according to the first embodiment. The drunk driving prevention apparatus 1 is an apparatus for preventing the drunken state of the vehicle (for example, an automobile) by the driver.

The drunk driving prevention apparatus 1 according to the first embodiment includes a drunken state detection sensor 11 (drunken state detection module), a drunken state determination part 12 (drunken state detection module), a vehicle control part 13 (control module), an emergency signal receiver 14 (detection module), a navigation system 15 (detection module), and a vehicle control release mechanism part 16 (control release module). The functions of some of the drunken state determination part 12, the vehicle control part 13, and the vehicle control release mechanism part 16 are implemented by an ECU which is an electronic control unit mounted in the vehicle.

The drunken state detection sensor 11 is a sensor which measures the level of inebriation of the driver. If the driver breathes on the drunken state detection sensor 11, the drunken state detection sensor 11 measures the alcohol concentration in the breath of the driver, and outputs and displays the level of inebriation. The drunken state detection sensor 11 is not particularly limited insofar as measurement of the level of inebriation (that is, a drunk test) is possible. A sensor may be used which measures the amount of drinking by the driver.

The drunken state determination part 12 determines whether the driver is in the drunken state or not on the basis of the level of inebriation measured by the drunken state detection sensor 11. When the drunken state detection sensor 11 is a sensor which measures the alcohol concentration, if the alcohol concentration measured by the drunken state detection sensor 11 is equal to or greater than a predetermined concentration, the drunken state determination part 12 determines that the driver is in the drunken state. When the drunken state detection sensor 11 is a sensor which measures the amount of drinking by the driver, if the amount of drinking measured by the drunken state detection sensor 11 is equal to or greater than a predetermined amount, the drunken state determination part 12 determines that the driver is the drunken state.

When the drunken state determination part 12 determines that the driver is in the drunken state, the vehicle control part 13 performs control (that is, interlock control) for retaining vehicle travel. Specific examples of control for retaining vehicle travel include stoppage of the engine of the vehicle, prevention of the start of the stopped engine, shutoff of fuel supply to the engine, and shutoff of current supply to the ignition system of the vehicle.

The emergency signal receiver 14 receives and acquires an emergency signal including disaster prevention information transmitted by a public electric-wave broadcast (for example, radio broadcast) and detects occurrence of an emergency on the basis of the emergency signal. Specific example of the disaster prevention information include a strong wind, high seas, flood, or fog watch/warning, earthquake information, tsunami information, volcano information, and typhoon information, as described below. The emergency signal receiver 14 may be a sensor which detects the occurrence of an emergency on the basis of an emergency broadcast by a disaster prevention speaker provided on the street (broadcast by a siren which means an emergency).

When emergency evacuation of the vehicle is required by the received emergency signal, if it is determined that the vehicle is present within the range represented by a circle of a predetermined radius (for example, 1 km) from a seismic center or a maximum seismic intensity point, if it is determined that the vehicle is present within the range in which the distance from a coast subject to tsunami to the vehicle is a predetermined distance (for example, 1 km), if it is determined that the vehicle is present within the range in which the distance from the crater of an erupting volcano to the vehicle is a predetermined distance (for example, 2 km), or if it is determined that the vehicle is present within the range in which the distance from an area where a flood occurs to the vehicle is a predetermined distance (for example, 2 km), the emergency signal receiver 14 determines that an emergency occurs.

The navigation system 15 receives traffic information regarding the current position of the vehicle and the like, and performs screen display of the traffic information or information to a destination based on the traffic information for the driver, and detects the occurrence of an emergency on the basis of the traffic information. The navigation system 15 has a VICS 151 (detection module) and a GPS receiver 152 (detection module), and perform screen display and detection by using traffic information output from the VICS 151 and the GPS receiver 152.

The navigation system 15 acquires the distance from the vehicle to a shelter for accommodating the driver to protect the driver, and detects an emergency, in which the driver is likely to be accommodated in the shelter for a long time, when the distance is equal to or greater than a predetermined distance. Specific examples of the shelter for protecting the driver include facilities, such as a fire station, a police station, and a hospital. The navigation system 15 stores information regarding the positions of the shelters, capacity, and a time zone to react in advance. The predetermined distance is the distance in a range of several km to several tens km, for example, 3 km. The navigation system 15 acquires the time required for travel to the shelter and detects an emergency, in which the driver is likely to be accommodated in the shelter for a long time, when it is estimated that the time is equal to or greater than a predetermined time. The predetermined time is the time in a range of several minutes to several tens of minutes, for example, 10 minutes.

The VICS 151 (Vehicle Information and Communication System) receives information transmitted from a beacon or the like provided near a road on which the vehicle is traveling, and displays traffic jam information on the navigation system 15. Information transmitted from a beacon or the like includes traffic information regarding a traffic jam or the like processed by the VICS center.

The GPS (Global Positioning System) receiver 152 measures the position of the vehicle on earth on the basis of the arrival time of an electric wave from a satellite, and displays positional information regarding the current location or the like on the navigation system 15.

The vehicle control release mechanism part 16 includes a release button having a mechanism, which is pressed for use in a predetermined case (or only in a predetermined case). The predetermined case means a case where the drunken state determination part 12 detects that the driver in the drunken state and the emergency signal receiver 14 detects occurrence of an emergency. If the press of the release button is permitted and the driver presses the release button, control for restraining vehicle travel by the vehicle control part 13 is released (that is, restraining control is stopped so as not to be performed) (that is, release of the interlock), and travel of the vehicle is permitted.

The vehicle control release mechanism part 16 is not particularly limited insofar as the restraining control can be released in the above-described case (or only in a predetermined case). A release switch, instead of the release button, may be used.

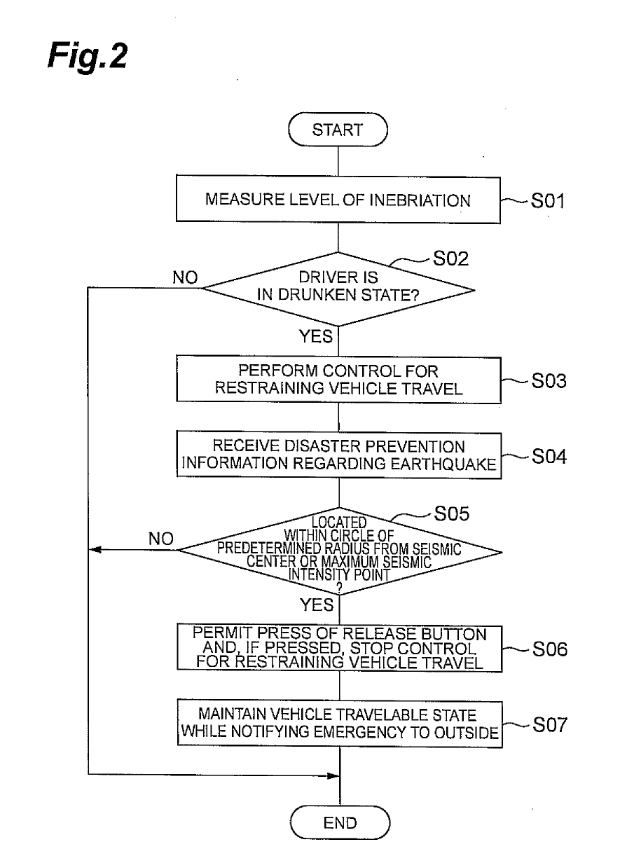

Subsequently, a sequence of measurement and determination processing from measurement of the level of inebriation and release of control for restraining vehicle travel, which is executed by the drunk driving prevention apparatus 1, will be described with reference to FIG. 2. FIG. 2 is a flowchart illustrating a sequence of measurement and determination processing which is executed by the drunk driving prevention apparatus 1. Although the drunken state detection sensor 11 is a sensor which measures the alcohol concentration, as described above, a sensor may be used which measures the amount of drinking by the driver. The processing shown in the flowchart of FIG. 2 is mainly carried out by the ECU. The processing starts when the drunk driving prevention apparatus 1 is turned on and is repeatedly executed at a predetermined time interval until the drunk driving prevention apparatus 1 is turned off.

First, if the driver breathes on the drunken state detection sensor 11, the drunken state detection sensor 11 measures the level of inebriation of the driver (Step S01).

Next, the drunken state determination part 12 determines whether the driver is in the drunken state or not on the basis of the level of inebriation measured by the drunken state detection sensor 11 (Step S02). When the alcohol concentration measured by the drunken state detection sensor 11 is smaller than a predetermined concentration, it is determined that the driver is not in the drunken state, and the sequence of processing ends. Meanwhile, when the alcohol concentration measured by the drunken state detection sensor 11 is equal to or greater than the predetermined concentration, it is determined that the driver is in the drunken state, and the process progresses to Step S03 described below.

In Step S03, the vehicle control part 13 performs the control (that is, the interlock control) for restraining vehicle travel. Then, the process progresses to Step S04 described below.

In Step S04, the emergency signal receiver 14 receives an emergency signal including disaster prevention information transmitted by a public electric-wave broadcast (for example, radio broadcast). The disaster prevention information relates to earthquake and is, for example, information regarding seismic intensity and a point where the seismic intensity is observed, a seismic center, a maximum seismic intensity point, and the like. Then, the process progresses to Step S05 described below.

In Step S05, the emergency signal receiver 14 determines whether the vehicle is present within the range represented by a circle of a predetermined radius (for example, 1 km) from the seismic center or maximum seismic intensity point or not on the basis of the received emergency signal. This determination is made by using information from the navigation system 15, the VICS 151, the GPS receiver 152, or the like. When it is determined that the vehicle is not present within the range represented by the circle, it is determined that no emergency occurs, and the sequence of processing ends. Meanwhile, when it is determined that the vehicle is present within the range represented by the circle, it is determined that an emergency occurs, and the process progresses to Step S06 described below.

In Step S06, the press for use of the release button provided in the vehicle control release mechanism part 16 is permitted. If the driver presses the release button, control for restraining vehicle travel by the vehicle control part 13 is released (that is, release of the interlock), and travel of the vehicle is permitted. Then, the process progresses to Step S07 described below.

In Step S07, a notification that an emergency occurs, so drunk driving in emergency is carried out in the vehicle is made to the outside. Specific examples of the notification include lighting of external lights and lamps provided in the vehicle, horn blaring, warning sound output, and the like. When this notification is being carried out, vehicle travel continues to be permitted, so the vehicle is traveling while this state is maintained. Then, the sequence of processing ends.

### (2) Second Embodiment

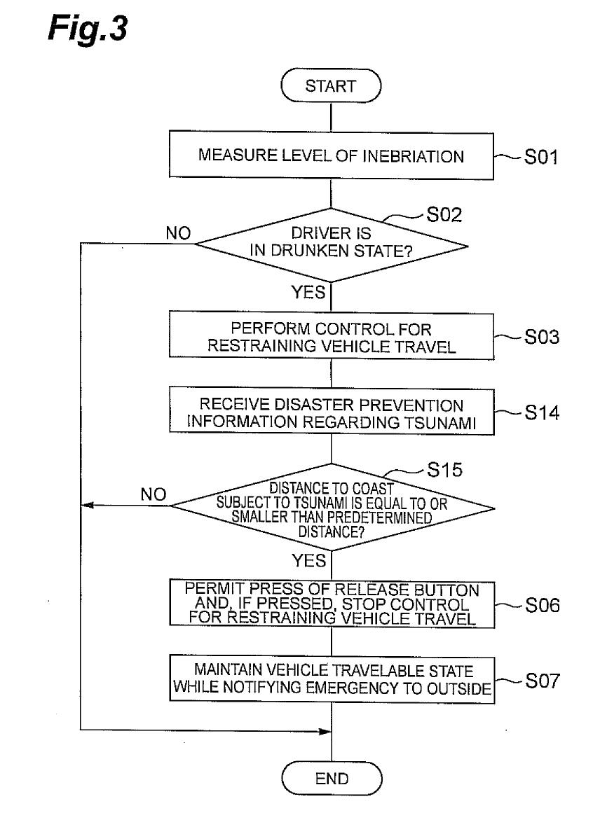

Next, a drunk driving prevention apparatus according to a second embodiment of the invention will be described with reference to FIG. 3. FIG. 3 is a flowchart illustrating a sequence of measurement and determination processing which is executed by the drunk driving prevention apparatus according to the second embodiment. The configuration of the drunk driving prevention apparatus according to the second embodiment is the same as that in the first embodiment, except for Steps S03 to S05. Other parts are the same as or similar to those in the first embodiment, and description thereof will not be repeated.

In Step S03, the vehicle control part 13 performs the control (that is, the interlock control) for restraining vehicle travel. Then, the process progresses to Step S14 described below.

In Step S14, the emergency signal receiver 14 receives an emergency signal including disaster prevention information transmitted by a public electric-wave broadcast (for example, radio broadcast). The disaster prevention information relates to a tsunami watch (warning) and is, for example, information regarding a coast and an area subject to a tsunami, the height of the tsunami, and the like. Then, the process progresses to Step S15 described below.

In Step S15, the emergency signal receiver 14 determines whether the distance from the vehicle to a coast and an area subject to a tsunami is equal to or smaller than a predetermined distance (for example, 1 km) or not on the basis of the received emergency signal. This determination is made by using information from the navigation system 15, the VICS 151, the GPS receiver 152, or the like. When it is determined that the distance from the vehicle to the coast and the area subject to the tsunami is greater than the predetermined distance, it is determined that no emergency occurs, and the sequence of processing ends. Meanwhile, when it is determined that the distance from the vehicle to the coast and the area subject to the tsunami is equal to or smaller than the predetermined distance, it is determined that an emergency occurs, and the process progresses to Step S06 described above.

### (3) Third Embodiment

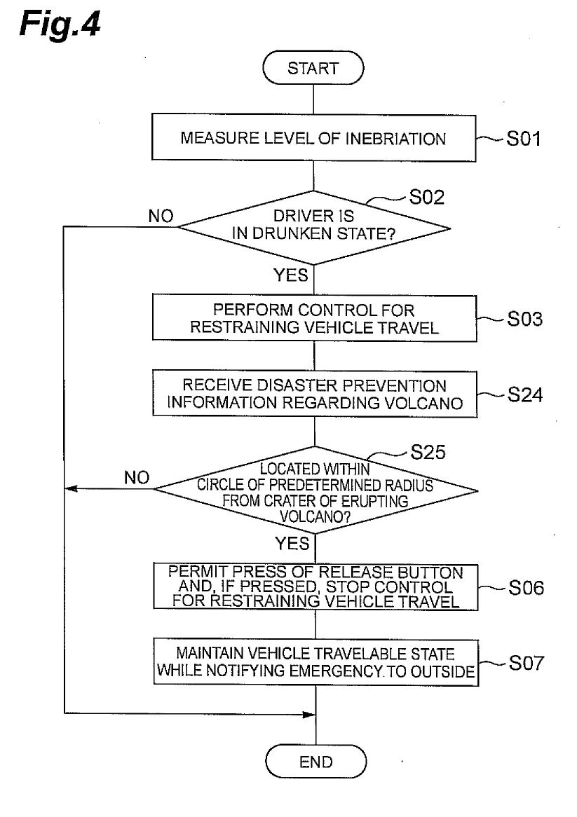

Next, a drunk driving prevention apparatus according to a third embodiment of the invention will be described with reference to FIG. 4. FIG. 4 is a flowchart illustrating a sequence of measurement and determination processing which is executed by the drunk driving prevention apparatus according to the third embodiment. The configuration of the drunk driving prevention apparatus according to the third embodiment is the same as that in the first embodiment, except for Steps S03 to 505. Other parts are the same as or similar to those in the first embodiment, and description thereof will not be repeated.

In Step S03, the vehicle control part 13 performs the control (that is, the interlock control) for restraining vehicle travel. Then, the process progresses to Step S24 described below.

In Step S24, the emergency signal receiver 14 receives an emergency signal including disaster prevention information transmitted by a public electric-wave broadcast (for example, radio broadcast). The disaster prevention information relates to a volcano and is, for example, information regarding whether a volcano has erupted or not, the position of the crater of the volcano when the volcano has erupted, and the like. Then, the process progresses to Step S25 described below.

In Step S25, the emergency signal receiver 14 determines whether the vehicle is present within the range represented by a circle of a predetermined radius (for example, 2 km) from the crater of the erupted volcano or not on the basis of the received emergency signal. This determination is made by using information from the navigation system 15, the VICS 151, the GPS receiver 152, or the like. When it is determined that the vehicle is not present within the range represented by the circle, it is determined that no emergency occurs, and the sequence of processing ends. Meanwhile, when it is determined that the vehicle is present within the range represented by the circle, it is determined that an emergency occurs, and the process progresses to Step S06 described above.

### (4) Fourth Embodiment

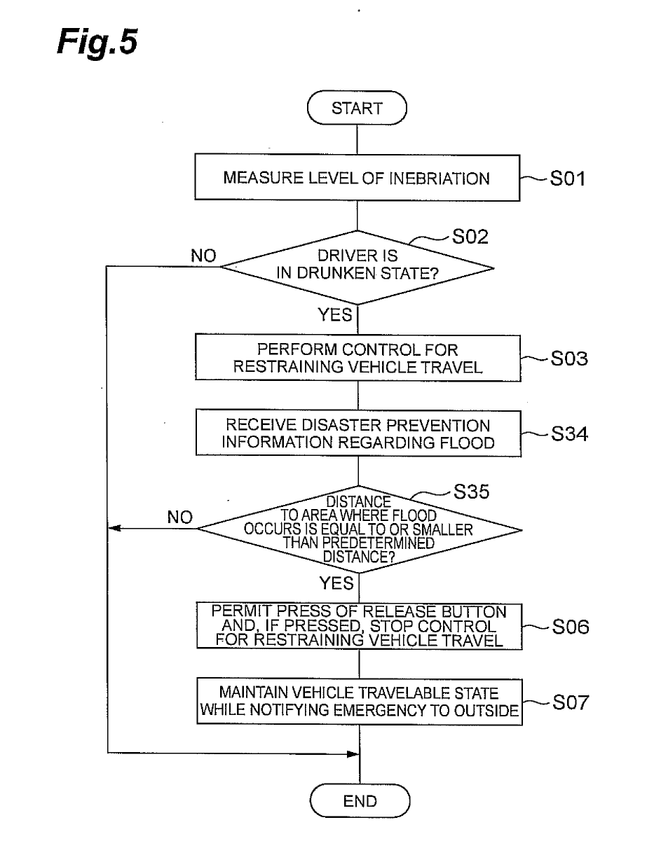

Next, a drunk driving prevention apparatus according to a fourth embodiment of the invention will be described with reference to FIG. 5. FIG. 5 is a flowchart illustrating a sequence of measurement and determination processing which is executed by the drunk driving prevention apparatus according to the fourth embodiment. The configuration of the drunk driving prevention apparatus according to the fourth embodiment is the same as that in the first embodiment, except for Steps S03 to 505. Other parts are the same as or similar to those in the first embodiment, and description thereof will not be repeated.

In Step S03, the vehicle control part 13 performs the control (that is, the interlock control) for restraining vehicle travel. Then, the process progresses to Step S34 described below.

In Step S34, the emergency signal receiver 14 receives an emergency signal including disaster prevention information transmitted by a public electric-wave broadcast (for example, radio broadcast). The disaster prevention information relates to a flood and is, for example, information regarding whether a flood has occurred or not, an area where the flood has occurred, and the like. Then, the process progresses to Step S35 described below.

In Step S35, the emergency signal receiver 14 determines whether the distance from the vehicle to the area where the flood has occurred is equal to or smaller than a predetermined distance (for example, 2 km) or not on the basis of the received emergency signal. This determination is made by using information from the navigation system 15, the VICS 151, the GPS receiver 152, or the like. When it is determined that the distance from the vehicle to the area where the flood has occurred is greater than the predetermined distance, it is determined that no emergency occurs, and the sequence of processing ends. Meanwhile, when it is determined that the distance from the vehicle to the area where the flood has occurred is equal to or smaller than the predetermined distance, it is determined that an emergency occurs, and the process progresses to Step S06 described above.

### (5) Fifth Embodiment

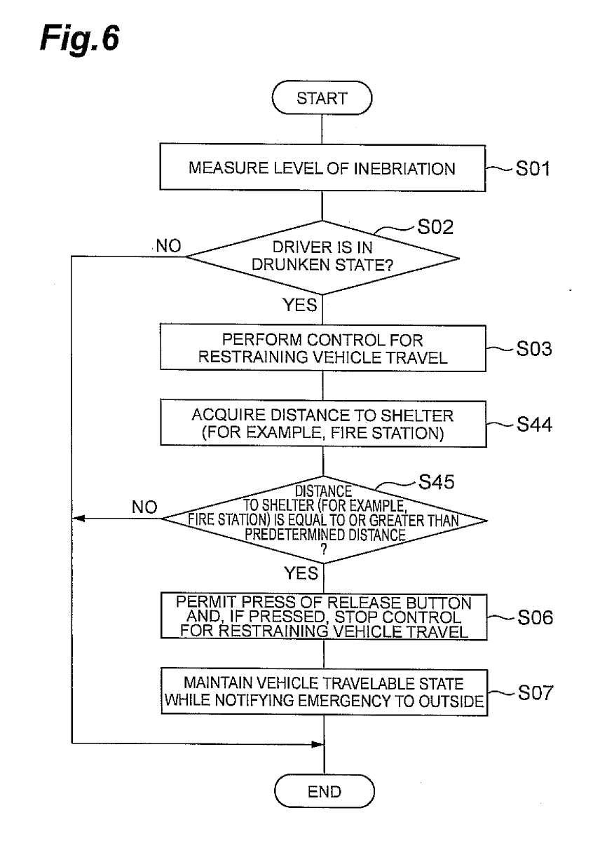

Next, a drunk driving prevention apparatus according to a fifth embodiment of the invention will be described with reference to FIG. 6. FIG. 6 is a flowchart illustrating a sequence of measurement and determination processing which is executed by the drunk driving prevention apparatus according to the fifth embodiment. The configuration of the drunk driving prevention apparatus according to the fifth embodiment is the same as that in the first embodiment, except for Steps S03 to S05. Other parts are the same as or similar to those in the first embodiment, and description thereof will not be repeated.

In Step S03, the vehicle control part 13 performs the control (that is, interlock control) for restraining vehicle travel. Then, the process progresses to Step S44 described below.

In Step S44, the navigation system 15 estimates and acquires the distance from the vehicle to a shelter (a fire station, a police station, a hospital, or the like) for protecting the driver on the basis of traffic information output from the VICS 151 and the GPS receiver 152 while taking into consideration a traffic jam and the like. Then, the process progresses to Step S45 described below.

In Step S45, the navigation system 15 determines whether the acquired distance (that is, the distance from the vehicle to the shelter) is equal to or greater than a predetermined distance (for example, 3 km). When it is determined that the distance from the vehicle to the shelter is smaller than the predetermined distance, it is determined that no emergency occurs, and the sequence of processing ends. Meanwhile, when it is determined that the distance from the vehicle to the shelter is equal to or greater than the predetermined distance, it is determined that an emergency occurs, and the navigation system 15 starts a virtual route guide to a shelter at a shortest distance from the shelters for the driver. Then, the process progresses to Step S06 described above.

### (6) Sixth Embodiment

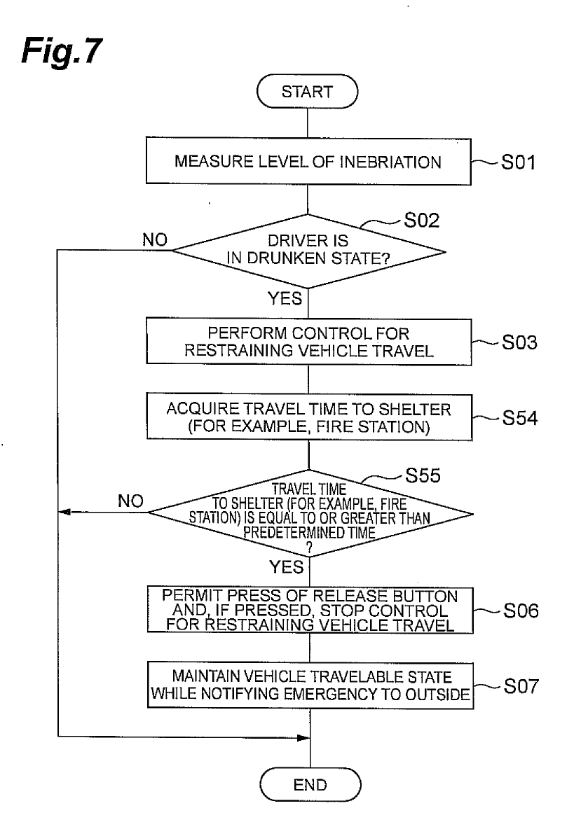

Next, a drunk driving prevention apparatus according to a sixth embodiment of the invention will be described with reference to FIG. 7. FIG. 7 is a flowchart illustrating a sequence of measurement and determination processing which is executed by the drunk driving prevention apparatus according to the sixth embodiment. The configuration of the drunk driving prevention apparatus according to the sixth embodiment is the same as that in the first embodiment, except for Steps S03 to S05. Other parts are the same as or similar to those in the first embodiment, and description thereof will not be repeated.

In Step S03, the vehicle control part 13 performs the control (that is, interlock control) for restraining vehicle travel. Then, the process progresses to Step S54 described below.

In Step S54, the navigation system 15 estimates and acquires the travel time from the vehicle to a shelter (a fire station, a police station, a hospital, or the like) on the basis of traffic information output from the VICS 151 and the GPS receiver 152 while taking into consideration a traffic jam and the like. Instead of the travel time, the estimated arrival time until a vehicle (an ambulance, a patrol car, a fire truck, or the like) for protecting the driver arrives at the current point of the driver may be estimated and acquired. Then, the process progresses to Step S55 described below.

In Step S55, the navigation system 15 determines whether the acquired travel time (or the estimated arrival time) is equal to or greater than a predetermined time (for example, 30 minutes) or not. When it is determined that the travel time (or the estimated arrival time) from the vehicle to the shelter is smaller than the predetermined time, it is determined that no emergency occurs, and the sequence of processing ends. Meanwhile, when it is determined that the travel time (or the estimated arrival time) from the vehicle to the shelter is equal to or greater than the predetermined time, it is determined that an emergency occurs, and the navigation system 15 starts a virtual route guide from a shelter, at which the vehicle arrives in the shortest period of time, from the shelters for the driver. Then, the process progresses to Step S06 described above.

(7) Advantages

Subsequently, the advantages of the first embodiment to the sixth embodiment will be described. According to the first embodiment to the fourth embodiment, when the drunken state of the driver is detected and the emergency signal receiver 14 detects occurrence of an emergency, the vehicle control release mechanism part 16 permits the release of control by the vehicle control part 13. Thus, even if a drunken state is detected, when occurrence of an emergency is detected, the release of control for restraining vehicle travel is permitted, so there is no case where the release of control for restraining travel of a vehicle, such as an automobile, is carried out at an inappropriate timing. For this reason, drunk driving can be reliably prevented while the release of control for restraining vehicle travel as movement mobility for emergency evacuation can be permitted at an appropriate timing.

According to the fifth embodiment, the navigation system 15 detects an emergency when the distance from the vehicle to a shelter is equal to or greater than a predetermined distance. For this reason, even if a drunken state is detected, when it is estimated that the distance is equal to or greater than the predetermined distance, the release of control for restraining vehicle travel is permitted. Thus, travel of the vehicle is permitted, and the driver in the drunken state can move to the shelter. Therefore, drunk driving can be reliably prevented while the release of control for restraining vehicle travel can be permitted at an appropriate timing.

According to the sixth embodiment, the navigation system 15 detects an emergency when it is estimated that the time required for travel from the vehicle to the shelter is equal to or greater than the predetermined time. For this reason, even if a drunken state is detected, when it is estimated that the time is equal to or greater than the predetermined time, the release of control for restraining vehicle travel is permitted. Thus, travel of the vehicle is permitted, and the driver in the drunken state can move to the shelter. Therefore, drunk driving can be reliably prevented while the release of control for restraining vehicle travel can be permitted at an appropriate timing.

Although the embodiments of the invention have been described, the invention is not limited to the embodiments. For example, although in the embodiments, when the drunken state determination part 12 detects that the driver is in the drunken state, and the emergency signal receiver 14 detects occurrence of an emergency, the press of the vehicle control release mechanism part 16 is permitted, in such a case, the control for restraining vehicle travel by the vehicle control part 13 may be automatically released.

Although in Step S45 of FIG. 6, when the distance from the vehicle to the shelter is equal to or greater than the predetermined distance, the process progresses to Step S06, when it is determined that the distance from the vehicle to the shelter is equal to or greater than the predetermined distance, and when it is determined that the travel time (or the estimated arrival time) from the vehicle to the shelter is equal to or greater than the predetermined time, the process may progress to Step S06.

### INDUSTRIAL APPLICABILITY

According to the invention, a drunk driving prevention apparatus can be provided which reliably prevents drunk driving while permitting the release of control for restraining vehicle travel at an appropriate timing.

1. A drunk driving prevention apparatus which prevents drunk driving of a vehicle by a driver, the apparatus comprising:
control module for performing control for retraining vehicle travel when the drunken state of the driver is detected;
detection module for detecting occurrence of an emergency; and
control release module for enabling the release of control by the control module when the drunken state of the driver is detected and the occurrence of an emergency is detected by the detection module.

2. The apparatus according to claim 1,
wherein the detection module detects the emergency when it is estimated that the distance from the vehicle to a shelter for protecting the driver is equal to or greater than a predetermined distance.

3. The apparatus according to claim 1,
wherein the detection module detects the emergency when it is estimated that the time required for travel from the vehicle to a shelter for protecting the driver is equal to or greater than a predetermined time.
